(19) United States
(12) Patent Application Publication
(10) Pub. No.: US 2025/0159349 A1
(43) Pub. Date: May 15, 2025

(54) ELECTRONIC DEVICE AND CONTROL METHOD OF IMAGE CAPTURING THEREOF

(71) Applicant: ASUSTeK COMPUTER INC., Taipei City (TW)

(72) Inventor: Chang-Tai Lee, Taipei City (TW)

(73) Assignee: ASUSTeK COMPUTER INC., Taipei City (TW)

(21) Appl. No.: 18/826,210

(22) Filed: Sep. 6, 2024

(30) Foreign Application Priority Data
Nov. 10, 2023 (TW) 112143355

(51) Int. Cl. H04N 23/69; H04N 23/62; H04N 23/63

(52) U.S. Cl. CPC H04N 23/69; H04N 23/62; H04N 23/631; H04N 23/633

(57) ABSTRACT

An electronic device and a control method of image capturing thereof are provided. The control method of image capturing includes: providing an image capturer to perform a recording operation on a dynamic image; receiving a zooming command to perform a zooming operation on a local area of a recorded image, and obtaining a zoomed image; generating a photographing start signal according to movement information of the image capturer, a magnification of the zooming operation, and a duration of the zoomed image; and performing a photographing operation on the local area of the recorded image according to the photographing start signal to obtain a static image.

### CROSS-REFERENCE TO RELATED APPLICATION

This application claims the priority benefit of Taiwan application serial no. 112143355, filed on Nov. 10, 2023. The entirety of the above-mentioned patent application is hereby incorporated by reference herein and made a part of this specification.

### BACKGROUND

### Technical Field

The disclosure relates to an electronic device and a control method of image capturing thereof, and particularly relates to an electronic device capable of zooming in and automatically taking photos during video recording, and a control method of image capturing thereof.

### Description of Related Art

As the photography capabilities of electronic devices continue to improve, the users often use electronic devices to record videos in certain situations. Besides video recording, the users may also want to take close-up photos of a specific object in the video.

According to the conventional technology, when the user has such needs, the user is required to switch the electronic device between the video recording mode and the photography mode for capturing static images, which is inconvenient.

### SUMMARY

The disclosure provides an electronic device and a control method of image capturing thereof. The control method includes: performing a recording operation on a dynamic image by providing an image capturer; performing a zooming operation on a local area of a recorded image by receiving a zooming command, and obtaining a zoomed image; automatically generating a photographing start signal according to movement information of the image capturer, a magnification of the zooming operation, and a duration of the zoomed image; and performing a photographing operation on the local area of the recorded image according to the photographing start signal to obtain a static image.

The electronic device of the disclosure includes an image capturer, a display, a sensor, and a controller. The image capturer is configured to perform a recording operation on a dynamic image. The display is configured to display a recorded image. The sensor is configured to sense movement information of the electronic device. The controller is coupled to the image capturer, the display, and the sensor. The controller is configured to: perform a zooming operation on a local area of the recorded image by receiving a zooming command, and display a zoomed image on the display; generate a photographing start signal according to movement information of the image capturer, a magnification of the zooming operation, and a duration of the zoomed image; and enable the image capturer to perform a photographing operation on the local area of the recorded image according to the photographing start signal to obtain a static image.

Based on the above, the electronic device according to the disclosure performs the zooming operation on the local area of the recorded image according to the zooming command during video recording. In addition, the electronic device determines whether the zoomed image at this time meets the photographing condition, and performs the photographing operation in response to the photographing condition being met. In this way, the electronic device performs the automatic photographing operation on the zoomed image during video recording, thereby improving the convenience of use.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a flowchart showing the control method of image capturing according to an embodiment of the disclosure.

FIG. 2A to FIG. 2C are schematic diagrams showing the control method of image capturing.

FIG. 3 is a flowchart showing the control method of image capturing according to another embodiment of the disclosure.

FIG. 4A is a schematic diagram showing the electronic device according to an embodiment of the disclosure.

FIG. 4B is a schematic diagram of implementation of the setting interface for the first threshold, the second threshold, and the third threshold according to an embodiment of the disclosure.

### DETAILED DESCRIPTION OF DISCLOSED EMBODIMENTS

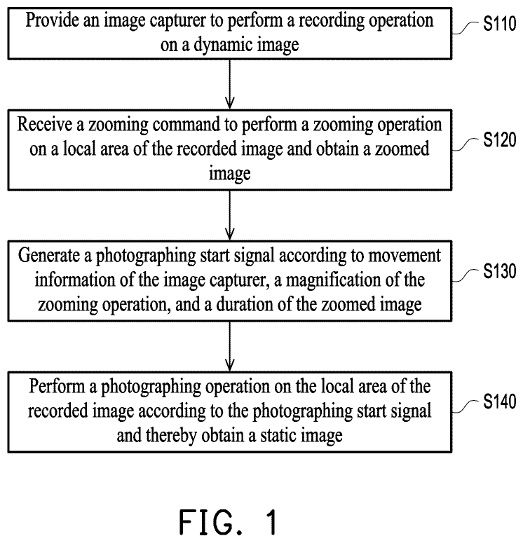

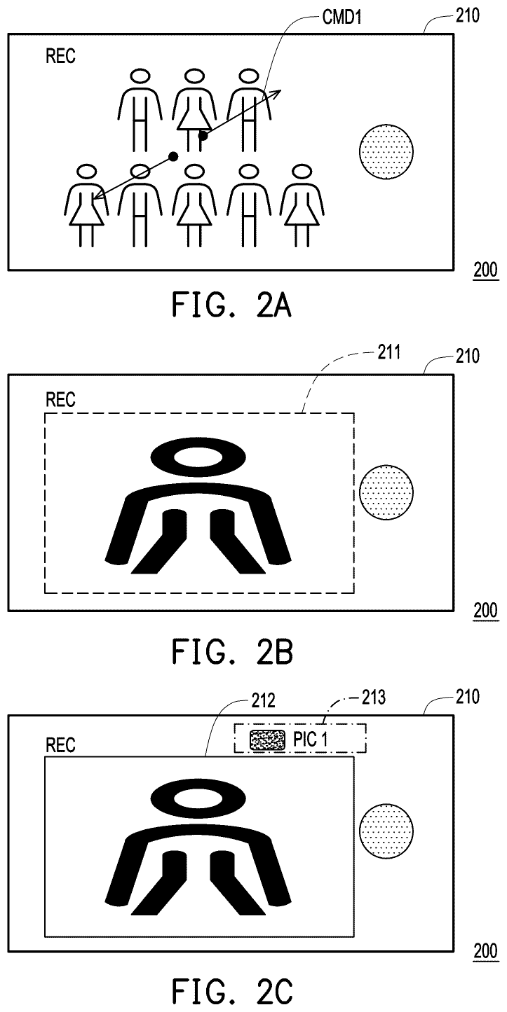

Please refer to FIG. 1 and FIG. 2A to FIG. 2C. FIG. 1 is a flowchart showing a control method of image capturing according to an embodiment of the disclosure, and FIG. 2A to FIG. 2C are schematic diagrams showing the control method of image capturing. Specifically, the control method in FIG. 1 may be executed by an electronic device 200 in FIG. 2. In step S110, the electronic device 200 may provide an image capturer to perform a recording operation on a dynamic image. Correspondingly, in FIG. 2A, the electronic device 200 may provide a display 210 to display a recorded image. Next, in step S120, the electronic device 200 may receive a zooming command, perform a zooming operation on a local area of the recorded image according to the zooming command, and obtain a zoomed image. In FIG. 2A, the display 210 may be a touch display. For example, the user may send a zooming command CMD1 to the electronic device through a gesture of moving away and enlarging the local area on the display 210. Further, in FIG. 2B, the electronic device 200 may zoom in the local area of the recorded image to obtain a zoomed image 211 according to the zooming command CMD1, and enable the display 210 to display the zoomed image 211.

Next, in step S130, the electronic device 200 may generate a photographing start signal according to movement information of the image capturer, a magnification of the zooming operation, and a duration of the zoomed image 211. In step S130, the electronic device 200 may perform a determination operation to determine whether a photographing condition is met. Specifically, the electronic device 200 may determine whether to activate an automatic photographing function by determining the stability of the image capturer, the magnification of the zooming operation, and whether the duration of the zoomed image being displayed on the display 210 is long enough.

In detail, the electronic device 200 may be provided with a sensor (such as a gravity sensor (G-sensor) or a gyroscope sensor) to obtain movement information of the electronic device 200. The electronic device 200 may determine whether a movement amount of the electronic device 200 is less than a first threshold according to the movement information so as to determine the stability of the electronic device 200. Further, the electronic device 200 may obtain the magnification according to a zoom factor in the received zooming command, and determine whether the size of the zoomed image 211 is large enough according to whether the magnification is greater than a second threshold. Furthermore, the electronic device 200 may calculate the duration after the zoom factor of the zooming command is determined and no longer changes to obtain the duration of the zoomed image being displayed on the display 210, and determine whether the duration of the zoomed image being displayed on the display 210 is long enough according to whether the above-mentioned duration is greater than a third threshold.

In addition, the photographing start signal may be enabled in response to the electronic device 200 determining that the image capturer is in a relatively stable state, the magnification of the zooming operation is sufficient, and the duration of the zoomed image being displayed on the display 210 is long enough.

In step S140, the electronic device 200 may perform a photographing operation on the local area 211 of the recorded image according to the photographing start signal and thereby obtain a static image 212, as shown in FIG. 2C. The electronic device 200 may enable the obtained static image 212 to be displayed on the display 210. Further, the display 210 may also display a photographing completion message 213 corresponding to the static image 212 at the same time. In FIG. 2C, the photographing completion message 213 includes a serial number of the static image 212, such as PIC 1, which is obtained through automatic photographing in the recording operation of the dynamic image.

It is worth mentioning that, in this embodiment, the recording operation continues during the process of automatic photographing. After capturing the static image 212, the display 210 may display the static image 212 for a preset period of time and then stop the display, and change to display the image being recorded.

It can be known from the above description that, in the embodiment of the disclosure, the electronic device may zoom in the local area of the recorded image during the recording operation of the dynamic image, and automatically perform the photographing operation on the zoomed local area in response to the photographing condition being met, which effectively reduces the complexity of capturing a static image from a dynamic image in the recording process and improves the convenience.

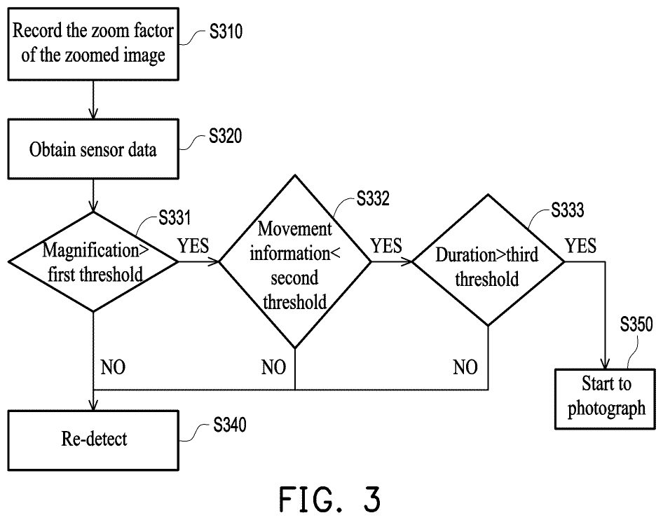

Please refer to FIG. 3 hereinafter, which is a flowchart showing a control method of image capturing according to another embodiment of the disclosure. In the case where the electronic device performs the recording operation, in response to the electronic device receiving a zooming command to generate a zoomed image, in step S310, the electronic device may record the zoom factor of the zoomed image, and obtain the magnification of the zoomed image according to the recorded zoom factor. Next, in step S320, the electronic device may obtain sensing data provided by a sensor provided on the electronic device. The sensor is, for example, a G-sensor or a gyroscope sensor, and is configured to sense movement information of the electronic device. In this embodiment, since the image capturer is disposed on the electronic device, the movement information of the electronic device may be equivalent to the movement information of the image capturer.

In step S331, the electronic device may determine whether the magnification of the zoomed image is greater than the first threshold, and execute step S332 in response to a determination result of YES. On the other hand, in response to a determination result of NO in step S331, step S340 is executed and a detection operation is performed again. In step S332, the electronic device may determine whether the movement information thereof is greater than the second threshold, and execute step S333 in response to a determination result of YES. Similarly, in response to a determination result of NO in step S332, step S340 is executed and the detection operation is performed again. In step S333, the electronic device may determine whether the duration of the zoomed image is greater than the third threshold, and execute step S350 to activate the photographing operation in response to a determination result of YES. Similarly, in response to a determination result of NO in step S333, step S340 is executed and the detection operation is performed again.

It is worth noting that, in this embodiment, the above-mentioned steps S331 to S333 are executed in sequence. However, in other embodiments of the disclosure, the order of executing steps S331 to S333 may be changed as required without specific limitations. Alternatively, steps S331 to S333 may also be executed synchronously and may not be executed in sequence. Nevertheless, step S350 is executed in response to all the determination results of steps S331 to S333 are YES. If the determination result of at least one of steps S331 to S333 is NO, step S340 is executed and the detection operation is performed again.

The above-mentioned first threshold, second threshold, and third threshold may all be preset values. In order to improve the convenience, the above-mentioned first threshold, second threshold, and third threshold may be adjusted by the user.

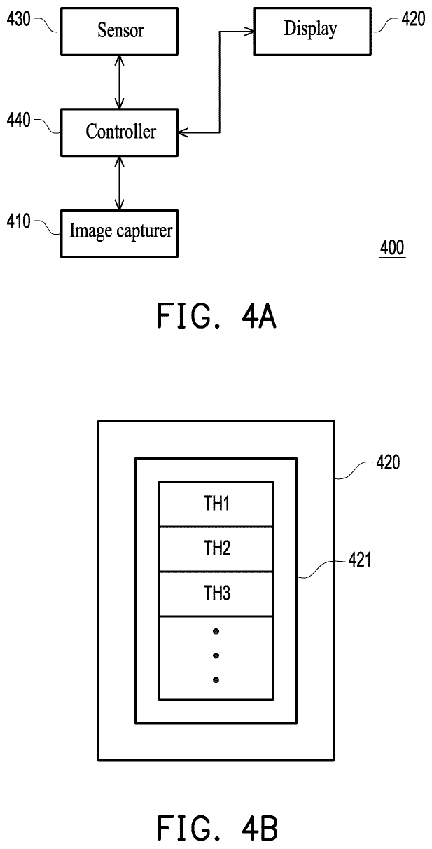

Please refer to FIG. 4A hereinafter. FIG. 4A is a schematic diagram of an electronic device according to an embodiment of the disclosure. The electronic device 400 includes an image capturer 410, a display 420, a sensor 430, and a controller 440. The controller 440 is coupled to the image capturer 410, the display 420, and the sensor 430. The image capturer 410 is configured to perform a recording operation on a dynamic image. The display 420 is configured to display a recorded image. The sensor 430 is configured to sense movement information of the electronic device 400.

Here, the sensor 430 is a gyroscope sensor, as an example. In response to an automatic photographing function being activated, the controller 440 may execute an algorithm during the recording operation. While executing the algorithm, in response to a zooming command being received, the controller 440 may record a zoom factor Zm for generating the zoomed image in the recording operation. The controller 440 also obtains X-axis, Y-axis, and Z-axis information of the gyroscope sensor from the sensor 430. In response to the controller 440 determining that the zoom factor Zm no longer changes, the controller 440 may then determine whether the zoom factor Zm is greater than the first threshold, and proceed to the next step in response to the zoom factor Zm being greater than the first threshold. Next, the controller 440 calculates the information of the three axes of the gyroscope sensor at this time, calculates the information changes dx, dy, and dz on the three axes of the gyroscope sensor, and calculates the displacement information of the electronic device 400 based on the information changes dx, dy, and dz. In response to the displacement information of the electronic device 400 being less than the second threshold, the controller 440 may time to determine whether the duration of this state is greater than the third threshold, and then start the automatic photographing operation.

Here, the sensing operation performed by the sensor 430 for sensing the displacement information may be implemented using gravity sensing technology known to those skilled in the art without specific limitations.

In this embodiment, the image capturer 410 may be a video recorder (or camera) that is capable of capturing static and dynamic images. The display 420 may be any form of display without specific limitations. The sensor 430 may be any device that is configured to sense movement information of the electronic device, such as a G-sensor or a gyroscope sensor.

In this embodiment, the controller 410 may be a hardware circuit that is designed using Hardware Description Language (HDL) or any other digital circuit design method known to those skilled in the art, and implemented through Field Programmable Gate Array (FPGA), Complex Programmable Logic Device (CPLD), or Application-specific Integrated Circuit (ASIC).

Please refer to FIG. 4B hereinafter. FIG. 4B is a schematic diagram of implementation of a setting interface for the first threshold, the second threshold, and the third threshold according to an embodiment of the disclosure. The electronic device 400 may provide a setting interface 421 through the display 420, allowing the user to set the first threshold, the second threshold, and the third threshold in FIG. 3. Through the touch function of the display 420, the user may click on the field on the setting interface 421 and input data in the selected field to perform the setting operation of setting at least one of the first threshold TH1, the second threshold TH2, and the third threshold TH3.

It goes without saying that the setting interface 421 in FIG. 4B is only an example for illustration. Designers may set up different forms of graphical or text setting interfaces for the user to set various parameters for the automatic photographing function.

To sum up, the electronic device according to the disclosure automatically and immediately executes the operation of capturing a static image of the local area during video recording in response to receiving a zooming command and determining that the photographing condition is met, which effectively improves the convenience of use of the electronic device.

What is claimed is:

1. A control method of image capturing, comprising:
performing a recording operation on a dynamic image by providing an image capturer;
performing a zooming operation on a local area of a recorded image by receiving a zooming command, and obtaining a zoomed image;
generating a photographing start signal according to movement information of the image capturer, a magnification of the zooming operation, and a duration of the zoomed image; and
performing a photographing operation on the local area of the recorded image according to the photographing start signal to obtain a static image.

2. The control method of image capturing according to claim 1, further comprising:
enabling the photographing start signal in response to the magnification being greater than a first threshold, the movement information being less than a second threshold, and the duration being greater than a third threshold.

3. The control method of image capturing according to claim 2, further comprising:
providing a setting interface through which a setting command is received to set at least one of the first threshold, the second threshold, and the third threshold.

4. The control method of image capturing according to claim 1, further comprising:
displaying the static image and generating a photographing completion message after completing the photographing operation.

5. The control method of image capturing according to claim 1, further comprising:
obtaining the magnification according to a zoom factor of the zooming command.

6. The control method of image capturing according to claim 1, further comprising:
detecting the movement information of the image capturer by providing a gravity sensor or a gyroscope sensor.

7. An electronic device, comprising:
an image capturer configured to perform a recording operation on a dynamic image;
a display configured to display a recorded image;
a sensor configured to sense movement information of the electronic device; and
a controller coupled to the image capturer, the display, and the sensor and configured to:
perform a zooming operation on a local area of the recorded image by receiving a zooming command, and display a zoomed image on the display;
generate a photographing start signal according to movement information of the image capturer, a magnification of the zooming operation, and a duration of the zoomed image; and
enable the image capturer to perform a photographing operation on the local area of the recorded image according to the photographing start signal to obtain a static image.

8. The electronic device according to claim 7, wherein the controller is further configured to enable the photographing start signal in response to the magnification being greater than a first threshold, the movement information being less than a second threshold, and the duration being greater than a third threshold.

9. The electronic device according to claim 8, wherein the display is further configured to provide a setting interface, and the controller is configured to receive a setting command through the setting interface to set at least one of the first threshold, the second threshold, and the third threshold.

10. The electronic device according to claim 7, wherein the controller is further configured to:
display the static image and a photographing completion message through the display after the photographing operation is completed.

11. The electronic device according to claim 7, wherein the controller is configured to obtain the magnification according to a zoom factor of the zooming command.

12. The electronic device according to claim 7, wherein the sensor is a gravity sensor or a gyroscope sensor.
